(19) United States
(12) Patent Application Publication
(10) Pub. No.: US 2022/0018698 A1
(43) Pub. Date: Jan. 20, 2022

(54) METHOD FOR MONITORING THE CONDITION OF A MEASUREMENT SENSOR

(71) Applicant: Endress+Hauser Flowtec AG, Reinach (CH)

(72) Inventor: Martin Josef Anklin, Dornach (CH)

(21) Appl. No.: 17/413,225

(22) PCT Filed: Nov. 11, 2019
(86) PCT No.: PCT/EP2019/080823

§ 371 Date: Jun. 11, 2021

(30) Foreign Application Priority Data
Dec. 11, 2018 (DE) 10 2018 131 686.0

(51) Int. Cl. G01F 1/84; G01F 25/00

(52) U.S. Cl. CPC G01F 1/8436; G01F 25/0007

(57) ABSTRACT

The method of the present disclosure is used to monitor a condition of a measurement sensor comprising an oscillator, which has a measuring tube for conveying the medium, and a condition parameter dependent upon a further physical parameter. The method comprises: determining tuples containing a value of the physical parameter and an associated value of the condition parameter; assigning the tuples to a value range of the physical parameter; and forming a reference value of the condition parameter for this value range of the physical parameter using the value of the condition parameter when no valid reference value of the condition parameter for this value range is present; or comparing the value of the condition parameter of the tuple with the reference value when a reference value of the condition parameter for this value range is present; and generating a finding on the basis of the result of the comparison.

The present invention relates to a method for monitoring a condition of a measurement sensor for detecting the density and/or mass flow rate of a medium, said measurement sensor being installed at a measuring point and comprising at least one oscillator which is excited to oscillate and which has at least one measuring tube for conveying the medium, wherein a condition parameter characterizing the condition is dependent upon at least one further parameter of the medium conveyed in the measuring tube or of the oscillator. A generic method is described, for example, in WO 03/029760 A1, DE 10 2011 086 395 A1, and WO 2013 072 164 A1.

A suitable parameter for condition monitoring can inter alia be the width of the resonance curve around a bending oscillation mode of the oscillator or an equivalent variable, such as the oscillation amplitude ratio between the oscillation of the oscillator at the resonant frequency of the bending oscillation mode and at a frequency deviating by a factor.

In order to be able to use a parameter reasonably for monitoring purposes, the parameter should firstly be sensitive in order to detect relevant condition changes in good time and secondly be sufficiently specific in order to be able to exclude false alarms.

The object of the present invention is to develop generic methods in this sense.

The object is achieved according to the invention by the method according to independent claim 1.

The method according to the invention serves to monitor a condition of a measurement sensor for detecting the density and/or mass flow rate of a medium, said measurement sensor being installed at a measuring point and comprising at least one oscillator which is excited to oscillate and which has at least one measuring tube for conveying the medium, wherein a condition parameter characterizing the condition depends upon at least one further physical parameter of the medium conveyed in the measuring tube or of the oscillator; wherein the method comprises the following steps:

determining tuples which contain a value of the at least one physical parameter and an associated value of the condition parameter;

assigning the tuples in each case to a value range of the at least one physical parameter; and

forming a reference value of the condition parameter for this value range of the at least one physical parameter using the value of the condition parameter of the tuple when no valid reference value of the condition parameter for this value range is present; or comparing the value of the condition parameter of the tuple with the reference value when a reference value of the condition parameter for this value range is present; and generating a finding on the basis of the result of the comparison.

Such a finding can be, for example, the determination of an error condition if the comparison results in a significant deviation from the reference value. In a development of the invention, such an error condition can be signaled, optionally in escalation levels which depend upon the degree of deviation.

In most cases, the condition parameter depends upon at least three physical parameters of the medium conveyed in the measuring tube, in particular the temperature, the density, and the pressure of the medium, wherein according to one development of the invention, the determined tuples respectively comprise current values of at least two of the physical parameters and an associated current value of the condition parameter; wherein the tuples are assigned to a field in a value range matrix of at least two of the physical parameters, in particular the density and temperature; wherein the reference value of the condition parameter is formed for this field of the value range matrix when a valid reference value of the condition parameter for this field is not yet present; wherein the comparison of the value of the condition parameter of the tuple with the reference value takes place when a reference value of the condition parameter for this field is present.

If the condition parameter depends upon at least three physical parameters of the medium guided in the measuring tube, in particular the temperature, the density, and the pressure of the medium, according to a development of the invention, the determined tuples respectively comprise current values of at least the three physical parameters and an associated current value of the condition parameter; wherein the tuples are assigned to a field in an at least three-dimensional value range matrix of the at least three physical parameters.

In a development of the invention, the valid reference values of the condition parameter for a value range or field of the value range matrix correspond in each case to the first detected value of the condition parameter for this value range or this field.

In a development of the invention, the valid reference values of the condition parameter for a value range or field of the value range matrix in each case are formed by averaging over N first values of the condition parameter for this value range or this field. In one embodiment of this development of the invention, in addition to the reference value, a measure for the dispersion of the first N values of the condition parameter, for example its standard deviation, is detected in each case, wherein a deviation of the current value of the condition parameter from the reference value is compared with the dispersion, in particular the standard deviation, in order to generate a finding on the basis of the result of the comparison.

According to a development of the invention, the value ranges for the temperature respectively cover not less than 5 K, in particular not less than 10 K.

According to a development of the invention, the value ranges for the density of the medium respectively cover not less than 50 kg/m³ K, in particular not less than 100 kg/m³ K.

According to a development of the invention, the value ranges for the pressure of the medium respectively cover not less than 0.5 MPa, in particular not less than 1 MPa.

According to a development of the invention, the condition parameter is configured to react to accretion, abrasion, and/or corrosion in the measuring tube.

According to a development of the invention, the at least one condition parameter depends upon the quality of the at least one oscillator.

According to a development of the invention, the at least one condition parameter depends upon at least one modal bending stiffness of the at least one oscillator.

According to a development of the invention, a ratio of an oscillation amplitude of the oscillator to an exciter signal for exciting the oscillations of the oscillator at at least one monitoring frequency is included in the determination of the condition parameter.

According to a development of the invention, the ratio between the monitoring frequency and a current resonant frequency of the oscillator, in particular the resonant frequency of a bending oscillation mode, is given by a constant factor.

According to a development of the invention, the condition parameter depends upon the line width of a bending oscillation mode of the oscillator, in particular the bending oscillation use mode of the oscillator or the function dω/dφ, wherein φ is the phase difference between the excitation signal and the oscillation amplitude of the oscillator.

The formation of a reference value of the condition parameter for a value range or for a field of a value range matrix presupposes at least one assigned tuple. The tuples of condition parameters and physical parameters are preferably determined continuously or periodically by measurement. However, it may happen that certain value ranges or fields of the value range matrix initially do not occur over a longer period of time after the start-up of a measuring point. No reference values can then be obtained for this purpose on the basis of a direct measurement. If, however, reference values for adjacent value ranges or for adjacent fields of the value range matrix are present in this case, the missing reference value can be determined by interpolation or extrapolation according to a development of the invention. In the simplest case, the interpolation or extrapolation can take place linearly. A non-linear fit of the reference values to the physical parameter or the physical parameters can likewise be carried out in a model-based manner according to an embodiment of this development of the invention. Insofar as a valid model for the reference values as a function of the physical parameters at a measuring point already exists, the plausibility of a newly observed reference value, which is detected as a function of the physical parameters in a new value range or field of the value range matrix, is checked according to a development of the invention, for example by comparison with a model-based expected value for the reference value.

In addition to determining the reference values, criteria as to which deviations determined in the comparison result in which finding must also be established for carrying out the method. Thus, in particular, from which deviation from the reference value an error condition is to be determined and optionally signaled. There is a variety of approaches in this respect.

Insofar as measuring point operators can very specifically define the requirements for a measuring point, it is advantageous if they can define and adapt the limit values for determining a significant deviation. Furthermore, for example, multiples of the standard deviation of a reference value, for example doubles or triples, or a percentage of the reference value, for example 8%, 4%, 2%, or 1%, can respectively serve as limit value. If reference values are determined by interpolation or extrapolation, it is advantageous if the limit values for deviations from extrapolated reference values are dimensioned to be greater than the limit values of deviations for interpolated reference values.

The invention gives consideration to the facts that, on the one hand, the measurement sensors in question are used at a wide variety of measuring points at which comparable values for the condition parameter or the physical parameters occur only to a limited extent, and that, on the other hand, the conditions at a specific measuring point are comparatively stable. In this way, measuring point-specific reference values can be determined, which make it possible to ascribe significance to even small deviations. According to Bayes, the following relationship applies to the probability P(A|B) of an event A when an event B has occurred:

P(A|B)=P(B|A)*P(A)/P(B).

The expression P(B|A) describes the probability of an event B when an event A has occurred, wherein P(A) and P(B) indicate the global probability that events A and B, respectively, occur at all, independently of an observation. If the event A is, for example, the actual occurrence of an error condition, and B is the occurrence of a significant change in the additional parameter, then the above formation of the reference variables achieves that, on the one hand, the sensitivity P(B|A) for the detection of the event A is increased, can be determined, and that, on the other hand, the selectivity is increased since reference values and optionally limit values are determined at a specific measuring point, whereby the global probability P(B) decreases for the measuring point. Both aspects result in an increased value for the probability P(A|B). That is to say, the trustworthiness of the indication of an error condition A increases due to the occurrence of B. By determining measuring point-specific reference variables as a function of boundary conditions, such as the temperature, the pressure, or the medium density, both the sensitivity and the selectivity can be increased even further.

The invention is now explained on the basis of the exemplary embodiments shown in the drawings. The following are shown:

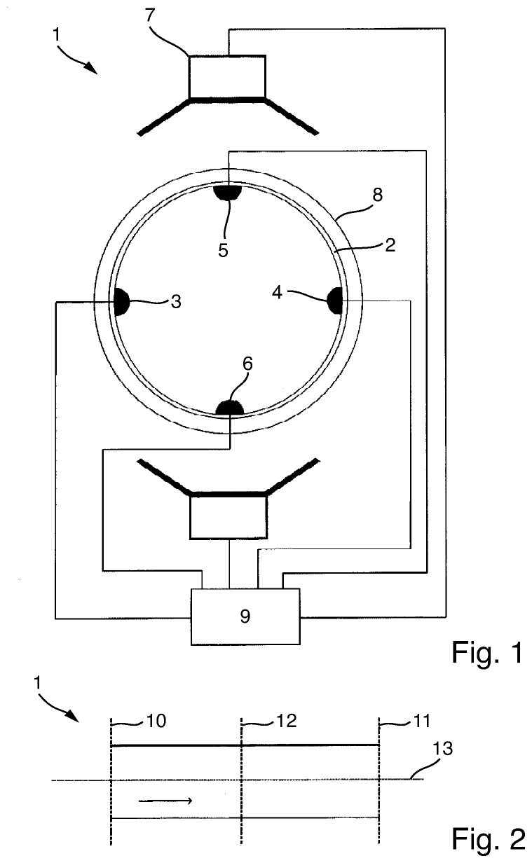

FIG. 1: an exemplary embodiment of a measuring point for carrying out the method according to the invention;

FIG. 2a: resonance curves of an oscillator for illustrating an exemplary embodiment of a condition parameter;

FIG. 2b: values for the deviation of the condition parameter of FIG. 2a as a function of the excitation frequency at two different quality levels of the oscillator;

FIG. 2c: values for the deviation of the condition parameter of FIG. 2a as a function of the quality level at three different reference quality levels;

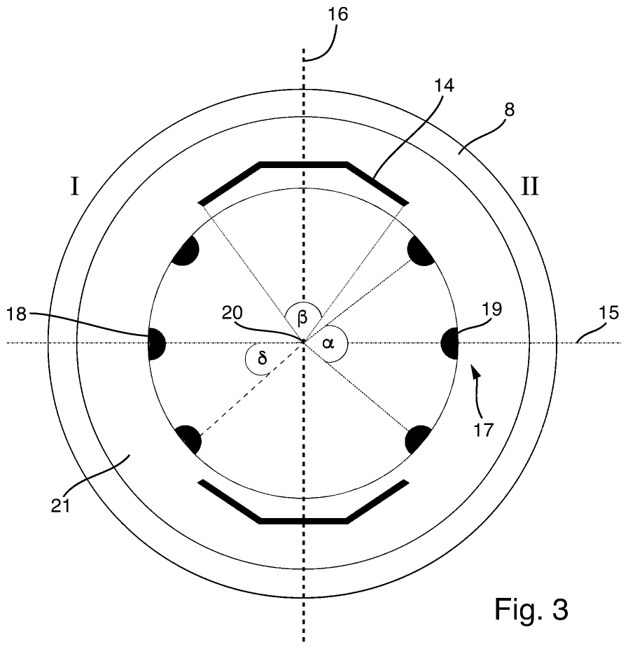

FIG. 3: an exemplary diagram of a value range matrix of a condition parameter as a function of the density and temperature; and

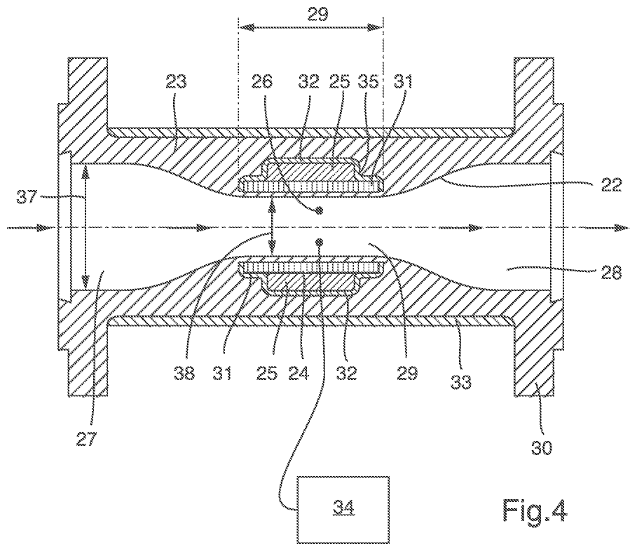

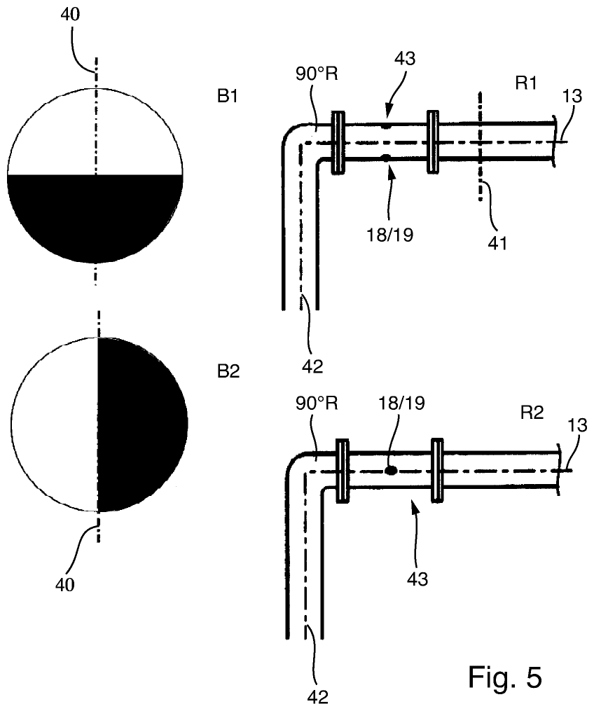

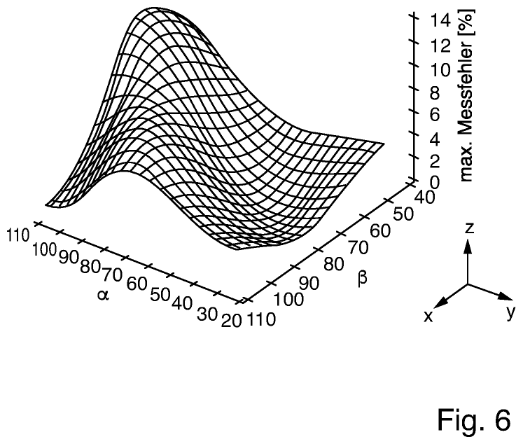

FIG. 4: a flow diagram of an exemplary embodiment of the method according to the invention.

The example shown in FIG. 1 of a measuring point 1 for carrying out the method according to the invention is arranged in a pipeline 10 in which a medium flows. The measuring point 1 comprises a Coriolis mass flow meter 20, which is configured to also detect the density of a medium in addition to the mass flow rates. Such a Coriolis mass flow meter 20 is manufactured, for example, by the applicant under the names Promass F, Promass Q, or Promass X. The Coriolis mass flow meter 20 comprises at least one oscillator 22 comprising two bent measuring tubes which are laid in parallel in a housing 24 and which can be excited to bending oscillations. The mass flow rate, the density, and the viscosity of the medium can be determined in a manner known per se from the oscillation behavior of the measuring tubes.

The flow meter 20 is shown in the drawing with a horizontal flow direction and a downward measuring tube bend. Naturally, the measuring tube bend can also be upward for improved drainability. Likewise, the flow meter can also be arranged with a vertical flow direction. The measuring point 1 furthermore comprises two pressure transducers 32 and 34, wherein the Coriolis mass flow meter 22 is arranged between the pressure transducers. The pressure of the medium in the Coriolis mass flow meter substantially results as the mean value of the measured values of the two pressure transducers. Insofar as the Coriolis mass flow meter has a restricted flow cross section in comparison with the pipeline, it forms a throttle between the two pressure transducers 32, 34 so that the viscosity of the medium can then be determined from the difference between their measured pressure values since the flow velocity is also known via the mass flow rate and the density of the medium. The pressure sensors of the pressure transducers may be absolute or relative pressure sensors. In this respect, the present invention does not have specific requirements since the pressure range permissible for the measuring point is divided into relatively rough pressure stages, and the pressure measurement substantially serves to determine in which pressure range the measuring point is currently located. Instead of the two pressure transducers, a single pressure transducer can also be used, for example an inlet-side pressure transducer 32, wherein the pressure prevailing in the measuring tubes can in this case be determined based on a measured pressure value and other media parameters, as disclosed, for example, in the published patent application DE 10 2010 000 759 A1. The measured pressure values of the one pressure transducer or of both pressure transducers are transmitted to the Coriolis mass flow meter and/or to a superordinate unit 240.

The Coriolis mass flow meter 20 furthermore comprises at least one temperature sensor, not shown here, for detecting a measured temperature value which is characteristic of the temperature of the medium or the temperature of the measuring tubes of the oscillator.

The Coriolis mass flow meter 20 furthermore comprises a measuring and operating circuit 26 which is at least configured to operate the flow meter 20, to determine measured values for the mass flow and optionally the density, and to output the determined measured values to the superordinate unit 240. Furthermore, the measuring and operating circuit 26, or optionally in combination with the superordinate unit 240, is configured to carry out the method according to the invention. That is to say, to initially collect reference values of at least one condition parameter for different value ranges or fields of a value range matrix and to then compare occurring values of the condition parameter with the reference values. An example of a condition parameter is described below with reference to FIGS. 2a-c.

FIG. 2a shows resonance curves of an oscillator as a function of the quotient of the exciter circuit frequency and the resonant circuit frequency δw/ωrₑₛ, wherein X/X₀:=X(ω/ω₀)/X(0) denotes the ratio between the circular-frequency-dependent amplitude and the amplitude in the static limit case. For illustration purposes, the resonance curves are shown here for extremely low quality levels Q having values of 10, 8, and 6. The oscillators of Coriolis mass flow meters actually have quality levels of 1,000 to 10,000, which are accompanied by substantially narrower and higher resonance maxima. The amplitude at the resonant circuit frequency _{ωres} is proportional to the quality level Q of an oscillator, wherein the influence of the quality level on the amplitude above the resonance loses significance quickly and is already largely negligible in the circled region in δFIG. 2a to which 1.1<ω/ωᵣₑₛ<1.3 applies. Thus, the ratio of the amplitude in the resonance case ω/ωᵣₑₛ=1 to the amplitude at, for example, ω/ωᵣₑₛ=1.15 is proportional to the quality level and independent of the amplitude of a periodic exciter force with which the oscillator is excited.

Accordingly, a suitable condition parameter Z for monitoring the oscillator condition would be Z=X(ω/ωᵣₑₛ)/X(1) at a defined circuit frequency ratio in the range of, for example, 1.1<ω/ωᵣₑₛ<1.3. For evaluating the condition, a deviation function D(Z) can then be formed, for example

D(Z):=(Z−Z_{ref})/Z_{ref}=Z/Z_{ref}−1.

FIG. 2b shows curves a function D (Z(w)), which is given with the above definitions as:

$$D ( Z ) = \frac{x ( \frac{ω}{{ω}_{res}} , Q )}{x ( 1 , Q )} \cdot \frac{x ( 1 , {Q}_{ref} )}{x ( \frac{ω}{{ω}_{res}} , {Q}_{ref} )} - 1 ,$$

where X(ω/ωᵣₑₛ, Q) is the observed amplitude at a circular frequency ω and a quality level Q. Q_{ref} denotes the quality level in the determination of the reference value of the condition parameter Z. The values for the quality level Q correspond to those in FIG. 2a, wherein the curve in FIG. 2a with the highest resonance peak corresponds to the reference condition. Accordingly, Q_{ref}=10 and Q=6 for the solid line and Q=8 for the dashed line applies to both curves in FIG. 2b. A weak frequency dependence of D can still be seen between 1.1<ω/ωᵣₑₛ<1.3, which is, however, negligible for large Q. Insofar as Z and D vary widely with Q, these are suitable functions for monitoring changes in the quality level Q.

FIG. 2c lastly shows curves of the above function D (Z(Q)), wherein in this diagram, Q is the independent variable whose change is to be monitored. Here, the circular frequency ratio was set to ω/ωrₑₛ=1.15. For the reference condition Z_{ref}, quality levels of Q_{ref}=10,000, 8,000, and 6,000 were set here. The respective deviation function D(Z) accordingly has a value deviating from zero when the quality level of the oscillator changes. If, during measurement operation, the deviation function D(Z) assumes values outside the range, whose limit values are indicated by the horizontal dash-dotted lines, this is evaluated as a significant change in the condition parameter Z and signaled accordingly.

After installation of a Coriolis mass flow meter or density measurement sensor into a measuring point and its start-up, reference values of a condition parameter Z for different value ranges of a physical parameter or fields of a value range matrix of different physical parameters are initially formed with regard to the method according to the invention, wherein the physical parameters, such as density, temperature, and pressure, define boundary conditions for the operation of the measuring point. Currently determined values of the condition parameter Z are assigned to a value range or a field in a value range matrix as a function of respectively given values of one or more physical parameters.

In the simplest case, the first value of the condition parameter, which is assigned to a value range or a field of a value range matrix, is detected as a reference value for the value range or the field of the value range matrix. Alternatively, the N first values of the condition parameter Z, which are assigned to a value range or a field in a value range matrix, are respectively stored for forming the reference value, wherein a mean value with associated standard deviation is then calculated and stored as a reference value for the value range or the field of the value range matrix.

For the method according to the invention, it is advantageous if the value ranges or fields of the value range matrix are not too small since the number of fields of the value range matrix may otherwise become very large. For example, temperature value ranges which respectively cover 10 K seem appropriate. For the density, value ranges that respectively cover 100 kg/m³ can, for example, be selected. Value ranges which respectively cover 1 MPa, for example, seem suitable for the media pressure. The width of the value ranges of a parameter may be the same as that of the simplicity. However, if it is foreseeable that the condition parameter can expect strong changes for certain value ranges of the physical parameters, for example at high temperatures and/or high pressure values, the width of the value ranges can be correspondingly reduced.

With reference to FIG. 3, a further aspect for determining reference values Z_{i,j} of a condition parameter for a value range matrix of two physical parameters, here the temperature T and the pressure p, is to be explained. A relative pressure of between 0 and 8 MPa, for example, can occur at the measuring point. This pressure range is divided into four value ranges. The media temperature can, for example, be between 20° C. and 140° C.; this temperature range is divided into five values ranges which respectively cover 20° C. The measuring point is used in a batch process in which, starting from atmospheric pressure and room temperature, the temperature and the pressure are initially increased along the solid trajectory to, for example, 130° C. and 7 MPa. The batch process subsequently proceeds along the dash-dotted trajectory back to room temperature. With each run of the process, values for the condition parameters Z for fields of the value range matrix passed through by the trajectories can now be determined by measurement. Therefore, soon after the start-up, reference values Z_{i,j} of the condition parameter are available for the corresponding fields of the value range matrix and are shown in italics and in bold in the graph. The condition of the measuring tube can therefore be monitored in each run of the batch process by comparing current values of the condition parameter of a tuple to the respective reference value. However, the reference values Z_{i,j} shown in normal font cannot be determined by measuring promptly after the start-up of the measuring point since the corresponding fields of the value range matrix do not occur in the case of the described process control. If, at a later point in time, a modified batch process is operated, which runs along the dotted trajectory, condition monitoring on the basis of measured reference values Z_{i,j} is only possible to a limited extent. For this case, the missing reference values can be calculated by interpolation or extrapolation of measured reference values Z_{i,j} and assigned to the fields of the value range matrix.

In addition to determining the reference values, criteria as to which deviations determined in the comparison result in which finding must also be established for carrying out the method. Thus, in particular, from which deviation from the reference value an error condition is to be determined and optionally signaled. Here, there is a variety of approaches, such as multiples of the standard deviation of a reference value, for example doubles or triples, a percentage of the reference value, for example 8%, 4%, 2%, or 1%.

It is advantageous if a plant operator can define the limit values themselves. For example, a cleaning requirement can be indicated on the basis of a change in a condition parameter. After a few operating cycles with cleaning of the measuring tube, the empirical basis is sufficient to set the limit value in such a way that the cleaning requirement is not signaled too early or too late.

FIG. 4 shows the method 100 according to the invention in summary:

In a first step 110, tuples of a condition parameter and of at least one physical parameter are determined and subsequently assigned to a value range of the physical parameter or to a field of a value range matrix of a plurality of physical parameters (115).

A query 120 checks whether a reference value is already present for the value range of the physical parameter or for the field of the value range matrix of a plurality of physical parameters; if so, what follows is a diagnosis 140 by comparison with the reference value, otherwise the formation of a reference value 160 in the manner described above.

1-15. (canceled)

16. A method for monitoring a condition of a measurement sensor for detecting the density or mass flow rate of a medium, said measurement sensor being installed at a measuring point and comprising at least one oscillator excited to oscillate, which has at least one measuring tube for conveying the medium, wherein a condition parameter of the condition is dependent upon at least one further physical parameter of the medium conveyed in the measuring tube or of the oscillator; wherein the method comprises:
determining tuples which contain a value of the at least one physical parameter and an associated value of the condition parameter;
assigning the tuples in each case to a value range of the at least one physical parameter; and
forming a reference value of the condition parameter for this value range of the at least one physical parameter using the value of the condition parameter of the tuple when no valid reference value of the condition parameter for this value range is present; or
comparing the value of the condition parameter of the tuple with the reference value when a reference value of the condition parameter for this value range is present; and generating a finding on the basis of the result of the comparison.

17. The method of claim 16, wherein the condition parameter depends upon at least three physical parameters of the medium conveyed in the measuring tube;
wherein the determined tuples respectively comprise current values of at least two of the physical parameters and an associated current value of the condition parameter;
wherein the tuples are assigned to a field in a value range matrix of the at least two of the physical parameters;
wherein forming the reference value of the condition parameter for this field of the value range matrix occurs when a valid reference value of the condition parameter for this value range is not yet present;
wherein the value of the condition parameter of the tuple is compared with the reference value when a reference value of the condition parameter for this field is present.

18. The method of claim 17, wherein the condition parameter depends upon at least three physical parameters of the medium conveyed in the measuring tube;
wherein the determined tuples respectively comprise current values of at least the three physical parameters and an associated current value of the condition parameter;
wherein the tuples are assigned to a field in an at least three-dimensional value range matrix of the at least three physical parameters.

19. The method of claim 16, wherein the valid reference values of the condition parameter for a value range or field of the value range matrix correspond in each case to the first detected value of the condition parameter for this value range or this field.

20. The method of claim 20, wherein the valid reference values of the condition parameter for a value range or field of the value range matrix are in each case formed by averaging over N first values of the condition parameter for this value range or this field.

21. The method of claim 20, wherein in addition to the reference value, a measure for the dispersion of the first N values of the condition parameter, wherein a deviation of the current value of the condition parameter from the reference value is compared with the dispersion in order to generate a finding on the basis of the result of the comparison.

22. The method of claim 16, wherein the value ranges for the temperature respectively cover not less than 5 K.

23. The method of claim 16, wherein the value ranges for the density of the medium respectively cover not less than 50 kg/m³ K.

24. The method of claim 16 according to one of the preceding claims, wherein the value ranges for the pressure of the medium respectively cover not less than 0.5 MPa.

25. The method of claim 16 according to one of the preceding claims, wherein the condition parameter is configured to react to accretion, abrasion, and/or corrosion.

26. The method of claim 16, wherein the at least one condition parameter depends upon the quality level of the at least one oscillator.

27. The method of claim 16, wherein the at least one condition parameter depends upon at least one modal bending stiffness of the at least one oscillator.

28. The method of claim 16, wherein a ratio of an oscillation amplitude of the oscillator to an exciter signal for exciting the oscillations of the oscillator at at least one monitoring frequency is included in the determination of the condition parameter.

29. The method of claim 16, wherein the ratio between the monitoring frequency and a current resonant frequency of the oscillator is given by a constant factor.

30. The method of claim 28, wherein the condition parameter depends upon the line width of a bending oscillation mode of the oscillator.
